(19) United States
(12) Patent Application Publication
(10) Pub. No.: US 2026/0314691 A1
(43) Pub. Date: Oct. 15, 2026

(54) ELECTRONIC ATOMIZATION DEVICE

(71) Applicant: SHENZHEN FIRST UNION TECHNOLOGY CO., LTD., Shenzhen, Guangdong (CN)

(72) Inventors: Rui WEN, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/483,115

(22) PCT Filed: May 7, 2024
(86) PCT No.: PCT/CN2024/091498

§ 371 Date: Nov. 10, 2025

(30) Foreign Application Priority Data
May 11, 2023 (CN) 202310530046.3

(51) Int. Cl. A24F 40/485; A24F 40/10; A24F 40/46; A24F 40/51; H05B 3/00; H05B 3/03

(52) U.S. Cl. CPC A24F 40/485; A24F 40/10; A24F 40/46; A24F 40/51; H05B 3/0019; H05B 3/03

(57) ABSTRACT

An electronic atomization device includes a mounting base body, a heating element, a battery, an air inlet channel, and an air outlet channel. A liquid storage cavity used for storing a liquid substrate is defined in the mounting base body. The heating element is provided on the mounting base body and used for heating the liquid substrate to generate an aerosol. The heating element is provided with an atomization surface for releasing the aerosol. The battery is arranged on and spaced apart from one side of the liquid storage cavity in the transverse direction and can supply power to the heating element. The air inlet channel is used as a channel for guiding external air to the atomization surface. The air outlet channel is used as a channel for discharging the aerosol. At least part of the air outlet channel is arranged between the liquid storage cavity and the battery.

### CROSS-REFERENCE TO RELATED APPLICATIONS

This application claims priority to Chinese Patent Application No. 202310530046.3, filed with the China National Intellectual Property Administration on May 11, 2023 and entitled “ELECTRONIC ATOMIZATION DEVICE”, which is incorporated herein by reference in its entirety.

### TECHNICAL FIELD

This application relates to the field of electronic atomization technologies, and in particular, to an electronic atomization device.

### BACKGROUND

An electronic atomization device is an atomization product that heats a liquid substrate to atomize the liquid substrate into an aerosol for a user to inhale. It is found through researching by an inventor that a center of a liquid storage cavity in an existing electronic atomization device includes a center air tube, and the center air tube is used as an air outlet channel. The center air tube not only affects observing the liquid substrate in the liquid storage cavity by the user, but also increases difficulty in manufacturing and assembly. Meanwhile, the existing electronic atomization device cannot effectively take away the atomized aerosol, and condensate is easily formed in the air outlet channel. The condensate may be drawn into a mouth of the user upon subsequent inhalation, leading to poor user experience.

### SUMMARY

To resolve the foregoing technical problem, an embodiment of this application provides an electronic atomization device.

The electronic atomization device includes:
a mounting substrate, where a liquid storage cavity is defined in the mounting substrate, and the liquid storage cavity is configured to store a liquid substrate;
a heating element, disposed on the mounting substrate, and configured to heat the liquid substrate to generate an aerosol; where the heating element includes an atomization surface configured to release the aerosol;
a battery, disposed spaced away along a transverse direction on one side of the liquid storage cavity, and configured to supply power to the heating element;
an air inlet channel, serving as a channel to guide external air to the atomization surface; and
an air outlet channel, serving as a channel to deliver the atomized aerosol outward.

At least a part of the air outlet channel is disposed between the liquid storage cavity and the battery. The heating element includes a first side and a second side opposite to each other. The atomization surface is defined between the first side and the second side. The air inlet channel is close to the first side, and the air outlet channel is close to the second side, so that an airflow from the air inlet channel flows from the first side to the second side and approaches the atomization surface.

In an optional solution of the foregoing electronic atomization device, the electronic atomization device further includes:
a mounting base, where the mounting base is disposed spaced away from the atomization surface of the heating element, to form an atomization cavity between the mounting base and the heating element.

In an optional solution of the foregoing electronic atomization device, the air inlet channel is disposed on the mounting base, and the air outlet channel is disposed on the mounting substrate. In an optional solution of the foregoing electronic atomization device, a vent channel is provided on the mounting substrate. One end of the vent channel communicates with the liquid storage cavity, and the other end communicates with the atomization cavity.

A liquid outlet hole is provided on the mounting substrate, and the liquid outlet hole is configured to enable the liquid substrate in the liquid storage cavity to flow to the heating element.

A port of the vent channel located in the liquid storage cavity is disposed spaced away from the liquid outlet hole.

In an optional solution of the foregoing electronic atomization device, the electronic atomization device further includes:
an airflow guide structure.

The airflow guide structure includes a first airflow guide wall and a second airflow guide wall. The first airflow guide wall and the second airflow guide wall are oppositely disposed along a width direction of the heating element. Rear ends of the first airflow guide wall and the second airflow guide wall both extend to opposite sides, to converge the airflow.

In an optional solution of the foregoing electronic atomization device, the airflow guide structure is disposed on the mounting base.

In an optional solution of the foregoing electronic atomization device, the first airflow guide wall and the second airflow guide wall are both arc-shaped. A front end of the first airflow guide wall is connected to a front end of the second airflow guide wall. A connection portion at least partially surrounds an opening portion of the air inlet channel.

In an optional solution of the foregoing electronic atomization device, an airflow sensor mounting cavity and an airflow channel are disposed on the mounting base. The airflow sensor mounting cavity is configured to mount an airflow sensor, and the airflow channel communicates the airflow sensor mounting cavity with the atomization cavity.

In an optional solution of the foregoing electronic atomization device, the mounting substrate includes a first end and a second end opposite to each other along a longitudinal direction of the mounting substrate. An opening is provided at the first end, and the opening communicates with the liquid storage cavity.

In an optional solution of the foregoing electronic atomization device, at least a part of the mounting substrate is set to a transparent structure, to observe the liquid substrate in the liquid storage cavity through the transparent structure.

In an optional solution of the foregoing electronic atomization device, the electronic atomization device further includes a housing configured to accommodate the mounting substrate. At least one of two sides of the housing along a thickness direction of the housing includes a window that exposes the transparent structure.

In an optional solution of the foregoing electronic atomization device, the air outlet channel includes a first air outlet channel and a second air outlet channel that extend in parallel in the mounting substrate.

In the foregoing electronic atomization device, the air inlet channel and the air outlet channel are respectively located at two sides of the heating element along the transverse direction, so that the air outlet channel is far away from the liquid storage cavity, instead of that an air outlet tube is disposed at a center of the liquid storage cavity in an existing technology. Therefore, there is no center air tube in the liquid storage cavity in the foregoing design. In this way, observing the liquid substrate in the liquid storage cavity by the user is not affected. Meanwhile, the air inlet channel and the air outlet channel are disposed at two sides of the heating element, so that the airflow from the air inlet channel flows in from the first side, passes through the atomization surface, and flows out from the second side. Therefore, the airflow flows parallel to the atomization surface, and the airflow is stable, so that more atomized aerosols can be taken away, utilization of the aerosols is higher, and user experience is better. In the foregoing electronic atomization device, the air outlet channel is at least partially disposed between the liquid storage cavity and the battery. After the user completes inhaling, residual heat of the battery may be used to continue to heat the aerosol retained in the air outlet channel, so as to avoid or relieve condensation of the aerosol in the air outlet channel. A part of the aerosol heated by the battery can further be exhausted outward, thereby relieving generation of condensate in the air outlet channel.

### BRIEF DESCRIPTION OF THE DRAWINGS

One or more embodiments are exemplarily described in the corresponding figures in the accompanying drawings. These exemplary descriptions do not constitute a limitation on the embodiments. In the accompanying drawings, elements having same reference numerals are represented as similar elements. Unless otherwise specified, the accompanying drawings do not constitute a proportion limitation.

FIG. 1 is a schematic diagram of a structure of an electronic atomization device according to an embodiment of this application;

FIG. 2 is a schematic diagram of a structure of an electronic atomization device in which a second housing is removed according to an embodiment of this application;

FIG. 3 is a schematic diagram of an exploded structure of an electronic atomization device according to an embodiment of this application;

FIG. 4 is a schematic diagram of an exploded structure of an electronic atomization device from another viewing angle according to an embodiment of this application;

FIG. 5 is a schematic diagram of a cross-section structure of an electronic atomization device according to an embodiment of this application;

FIG. 6 is a schematic diagram of another cross-section structure of an electronic atomization device according to an embodiment of this application;

FIG. 7 is a schematic diagram of a structure of a mounting substrate according to an embodiment of this application;

FIG. 8 is a schematic diagram of a cross-section structure of a mounting substrate according to an embodiment of this application; and

FIG. 9 is a schematic diagram of a structure of a mounting base according to an embodiment of this application.

In the figures:
100. Electronic atomization device; 101. Battery; 102. Air hole;
110. Mounting substrate; 111. Liquid storage cavity; 1111. Liquid outlet hole; 1112. Vent channel; 1113. Opening; 112. Mounting cavity; 113. Battery cavity;
120. Heating element; 121. Liquid absorbing surface; 122. Atomization surface; 123. Second sealing member;
130. Air inlet channel;
140. Air outlet channel;
150. Mounting base; 151. Atomization cavity; 152. Airflow guide structure; 1521. First airflow guide wall; 1522. Second airflow guide wall; 153. Electrode post; 154. Fixing post; 155. Airflow sensor mounting cavity; 1551. Third sealing member; 156. Airflow channel;
160. Suction nozzle; 161. First sealing member;
170. Bottom cover; 171. Charging port;
180. Housing; 181. Window;
190. Circuit board; and 191. Airflow sensor.

### DETAILED DESCRIPTION

For ease of understanding of this application, the following describes this application in more details with reference to the accompanying drawings and specific implementations. The specific implementations are merely used to explain this application, but are not intended to limit this application. In addition, it should be further noted that, for ease of description, the accompanying drawings only show a part rather than all of structures related to this application.

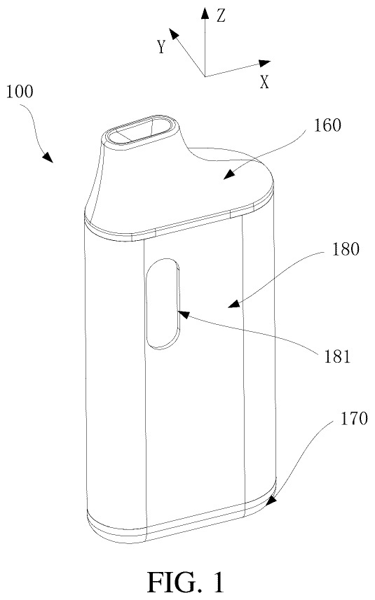

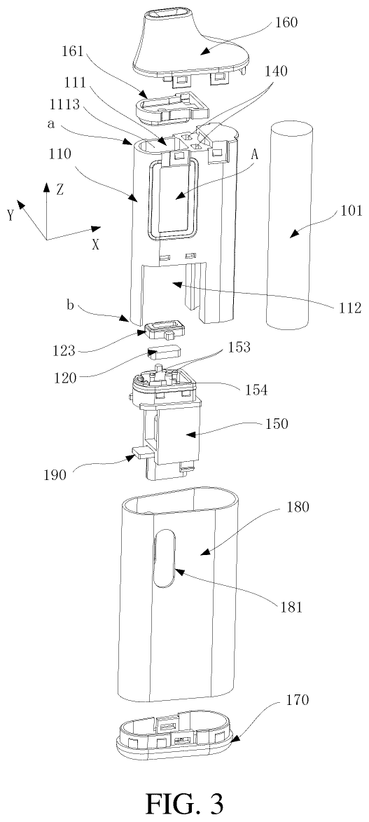

An embodiment of this application provides an electronic atomization device. With reference to FIG. 1 to FIG. 6, an electronic atomization device 100 includes a mounting substrate 110, a heating element 120, and a battery 101. As shown in FIG. 3 to FIG. 5, a liquid storage cavity 111 is defined in the mounting substrate 110. The liquid storage cavity 111 is configured to store a liquid substrate. For example, the liquid substrate may include one or more of components such as glycerol, propylene glycol, a nicotine preparation, a flavor and fragrance, and a flavor additive, and certainly, may alternatively be another type of liquid substrate.

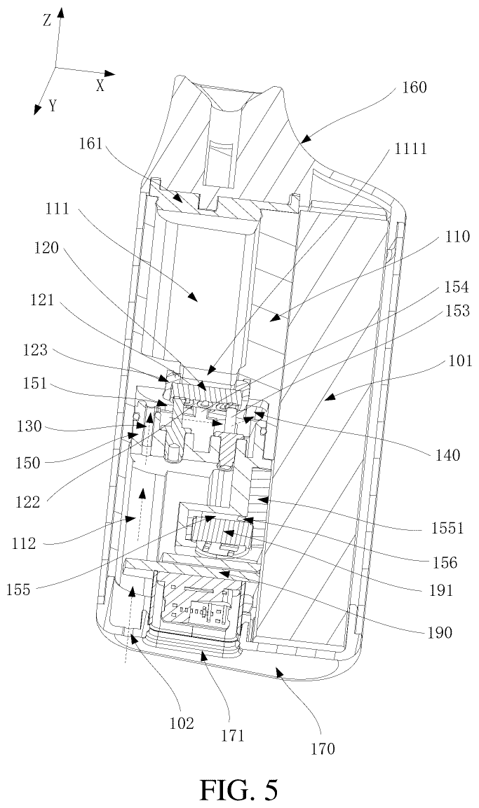

As shown in FIG. 5, the heating element 120 is disposed on the mounting substrate 110, and the heating element 120 is configured to heat the liquid substrate to generate an aerosol. The heating element 120 includes a first side surface and a second side surface opposite to each other along a longitudinal direction. As shown in FIG. 5, the first side surface is a liquid absorbing surface 121, and the second side surface is an atomization surface 122. The atomization surface 122 is configured to release the aerosol. A heat-generation element such as a heating wire, a heating circuit, or a heating film is disposed on the atomization surface 122, so that the liquid substrate can be atomized. The heating element 120 may be a porous member. As shown in FIG. 5, the liquid absorbing surface 121 is close to the liquid storage cavity 111, and is in contact with the liquid substrate in the liquid storage cavity 111. After the liquid absorbing surface 121 is in contact with the liquid substrate in the liquid storage cavity 111, the liquid substrate flows from the liquid absorbing surface 121 along holes in the heating element 120 to the atomization surface, and is heated and atomized on the atomization surface 122. The atomization surface 122 heats the liquid substrate to generate the aerosol.

The battery 101 is disposed spaced away along a transverse direction on one side of the liquid storage cavity 111, and is configured to supply power to the heating element 120. In this embodiment of this application, the transverse direction may be understood as a direction X shown in the accompanying drawings, the longitudinal direction may be understood as a direction Z shown in the accompanying drawings, and a thickness direction may be understood as a direction Y shown in the accompanying drawings. The direction Z, the direction X, and the direction Y shown in the accompanying drawings may alternatively be understood as an up-down direction, a left-right direction, and a front-rear direction of the electronic atomization device 100.

With reference to FIG. 5, the electronic atomization device 100 further includes an air inlet channel 130 and an air outlet channel 140. The air inlet channel 130 serves as a channel to guide external air to the atomization surface 122, and the air outlet channel 140 serves as a channel to deliver the atomized aerosol outward. In this embodiment of this application, as shown in FIG. 3 and FIG. 5, the air outlet channel 140 is at least partially disposed between the liquid storage cavity 111 and the battery 101. In such a design, after the user completes inhaling, residual heat of the battery 101 may be used to continue to heat the aerosol retained in the air outlet channel 140, so as to avoid or relieve condensation of the aerosol in the air outlet channel 140. A part of the aerosol heated by the battery 101 can further be exhausted outward, thereby relieving generation of condensate in the air outlet channel 140.

As shown in FIG. 5, the heating element 120 includes a first side and a second side opposite to each other. The first side and the second side may be understood as two sides of the heating element 120 along the transverse direction (the direction X) in FIG. 5. The atomization surface is defined between the first side and the second side. The air inlet channel 130 is close to the first side, and the air outlet channel 140 is close to the second side. The air inlet channel 130 and the air outlet channel 140 are respectively located on two sides of the heating element 120. As shown by dashed-line arrows in FIG. 5, an airflow from the air inlet channel 130 flows from the first side to the second side and approaches the atomization surface 122. Therefore, the airflow from the air inlet channel 130 flows parallel to the atomization surface 122, and the airflow is stable, so that more atomized aerosols can be taken away.

Meanwhile, the air inlet channel 130 and the air outlet channel 140 are disposed on two sides of the heating element 120, so that the air outlet channel 140 is far away from the liquid storage cavity 111, and therefore, there is no center air tube in the liquid storage cavity 111. In this way, observing the liquid substrate in the liquid storage cavity 111 by the user is not affected.

In an embodiment, as shown in FIG. 5, the electronic atomization device 100 further includes a mounting base 150. The mounting base 150 is disposed on a side of the atomization surface 122 of the heating element 120. As shown in FIG. 5, the mounting base 150 is disposed spaced away from the atomization surface 122 of the heating element 120, to form an atomization cavity 151 between the mounting base 150 and the heating element 120. The heating element 120 is located above the atomization cavity 151, and the atomization cavity 151 provides a space for the heating element 120 to perform atomization. It may be understood that the air inlet channel 130 and the air outlet channel 140 both communicate with the atomization cavity 151. As shown in FIG. 5, an inlet airflow of the air inlet channel 130 enters from a left side of the atomization cavity 151, flows parallel to the atomization surface 122 to take away the atomized aerosol, and flows out from the air outlet channel 140 on a right side of the atomization cavity 151.

With reference to FIG. 3 and FIG. 5, the air inlet channel 130 is disposed on the mounting base 150, and the air outlet channel 140 is disposed on the mounting substrate 110. No other components need to be additionally disposed to form the air channels. In this embodiment of this application, the mounting substrate 110 and the mounting base 150 may both be made of a plastic material, and the corresponding air channels are integrally formed on the mounting substrate 110 and the mounting base 150 through injection molding.

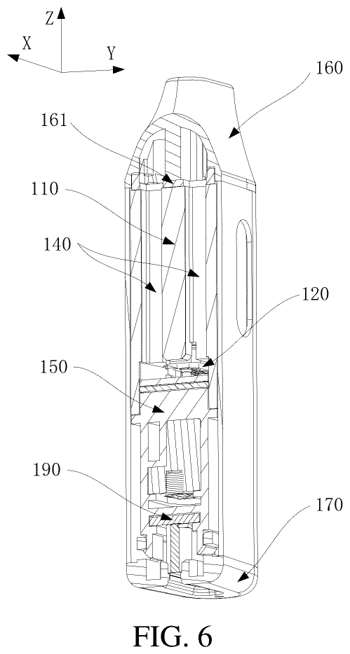

To avoid a case that the user fails to inhale the aerosol due to blockage of the air outlet channel 140, as shown in FIG. 3 and FIG. 6, two air outlet channels 140 may be disposed. To be specific, the air outlet channel 140 includes a first air outlet channel and a second air outlet channel, and the first air outlet channel and the second air outlet channel extend in parallel in the mounting substrate. In this way, when one of the air outlet channels 140 is blocked, the other can still be normally used. The two air outlet channels 140 extend along the direction Z. Certainly, in another embodiment, an air channel with a large cross section may alternatively be directly disposed to replace the two air outlet channels 140 in this embodiment.

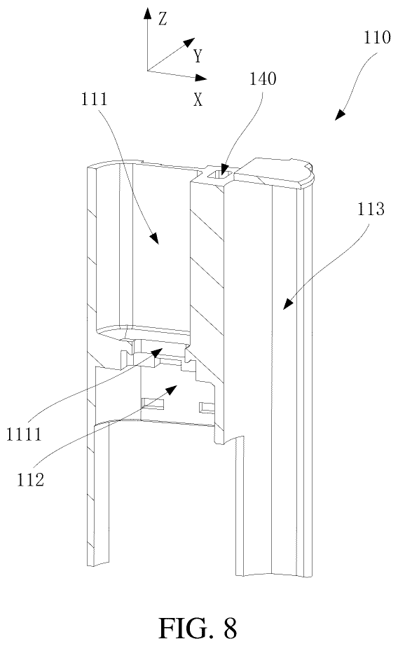

With reference to FIG. 5 and FIG. 8, a mounting cavity 112 and a battery cavity 113 are further disposed on the mounting substrate 110. The mounting cavity 112 and the liquid storage cavity 111 are sequentially arranged along the longitudinal direction, and the battery cavity 113 is located on a side of the mounting cavity 112 and the liquid storage cavity 111 along the transverse direction. In other words, the mounting cavity 112 is located below the liquid storage cavity 111, and the battery cavity 113 is located om a right side of the mounting cavity 112 and the liquid storage cavity 111. The mounting base 150 is disposed in the mounting cavity 112, and the battery 101 is mounted in the battery cavity 113.

As shown in FIG. 5, an air hole 102 may be disposed at a bottom of the electronic atomization device 100. The air hole 102 communicates the outside with the mounting cavity 112, so that external air enters the mounting cavity 112. In this way, the air flows to the atomization surface 122 through the air inlet channel 130 on the mounting base 150 in the mounting cavity 112. The air hole 102 is disposed at the bottom, so that an appearance of the electronic atomization device 100 is more beautiful.

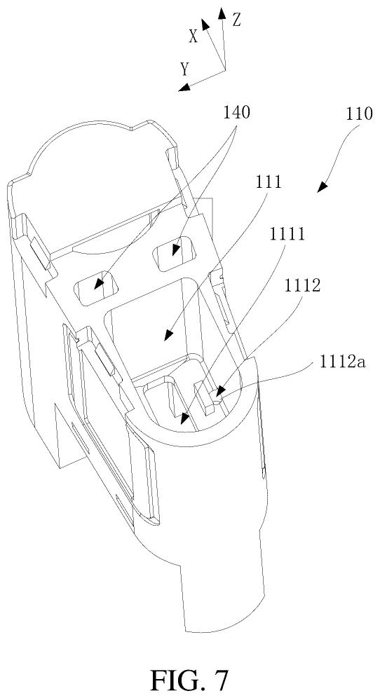

FIG. 7 is a schematic diagram of a structure of an embodiment of the mounting substrate. As shown in FIG. 7, a vent channel 1112 is provided on the mounting substrate 110. One end of the vent channel 1112 communicates with the liquid storage cavity 111, and the other end communicates with the atomization cavity 151. The vent channel 1112 is configured to supply gas to the liquid storage cavity 111 when the liquid substrate in the liquid storage cavity 111 flows out and causes a negative pressure in the liquid storage cavity 111, to balance a pressure in the liquid storage cavity 111. As shown in FIG. 7, a liquid outlet hole 1111 is further provided on the mounting substrate 110. The liquid outlet hole 1111 is configured to enable the liquid substrate in the liquid storage cavity 111 to flow to the heating element 120. One end of the liquid outlet hole 1111 communicates with the liquid storage cavity 111, and the other end extends to the heating element 120. In this embodiment of this application, a port 1112a of the vent channel 1112 located in the liquid storage cavity is disposed spaced away from the liquid outlet hole 1111, in other words, the vent port in the liquid storage cavity is far away from the liquid outlet hole 1111. In this way, a risk that vent bubbles block the liquid outlet hole 1111 can be reduced, thereby ensuring normal flowing out by the liquid substrate from the liquid outlet hole 1111, and preventing the heating element 120 from being dry heated and generating a burnt smell.

As shown in FIG. 7, a port of the end of the vent channel 1112 located in the liquid storage cavity 111 is attached to an inner side wall of the liquid storage cavity 111. In this way, the air ventilation port may be farther from the liquid outlet hole 1111 as much as possible.

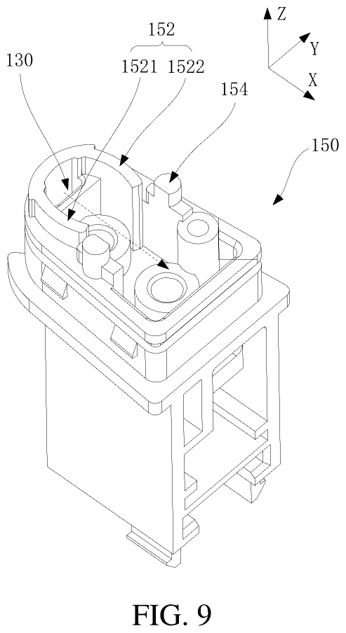

As shown in FIG. 9, in this embodiment of this application, the electronic atomization device 100 further includes an airflow guide structure 152. The airflow guide structure 152 is configured to guide the airflow to the heating element 120. With reference to FIG. 9, the airflow guide structure 152 may be disposed on the mounting base 150. In another embodiment, the airflow guide structure 152 may alternatively be a separately disposed structure, for example, a separately disposed airflow guide sheet.

With reference to FIG. 9, the airflow guide structure 152 includes a first airflow guide wall 1521 and a second airflow guide wall 1522. The first airflow guide wall 1521 and the second airflow guide wall 1522 are oppositely disposed along a width direction of the heating element, and the width direction is the direction Y shown in FIG. 9. In other words, the first airflow guide wall 1521 and the second airflow guide wall 1522 are respectively located on two sides of the heating element 120 along the direction Y. Rear ends of the first airflow guide wall 1521 and the second airflow guide wall 1522 both extend to opposite sides, to converge the airflow. The “rear end” described herein refers to a rear end along a general flow direction of the airflow. As shown in FIG. 9, the rear end of the first airflow guide wall 1521 extends to the second airflow guide wall 1522, and the rear end of the second airflow guide wall 1522 extends to the first airflow guide wall 1521, so that the rear ends of the two airflow guide walls converge to gather the airflow to the heating element 120.

In an embodiment, as shown in FIG. 9, in this embodiment of this application, the airflow guide structure 152 is disposed on the mounting base 150. The first airflow guide wall 1521 and the second airflow guide wall 1522 are both arc-shaped. A front end of the first airflow guide wall 1521 is connected to a front end of the second airflow guide wall 1522, and a connection portion at least partially surrounds an opening portion of the air inlet channel 130, to encase the airflow flowing in from the air inlet channel 130, thereby avoiding airflow leakage. The rear end of the first airflow guide wall 1521 and the rear end of the second airflow guide wall 1522 both converge toward a center of the atomization cavity 151 to guide the airflow to the center of the atomization cavity 151, in other words, to the atomization surface 122, so that the airflow passing through the atomization surface 122 is larger, to avoid a case that a part of the airflow flows away without passing through the atomization surface 122.

As shown in FIG. 9, a height of an end surface of one end of the first airflow guide wall 1521 and the second airflow guide wall 1522 close to the heating element 120 along the longitudinal direction (direction Z) is greater than a height of an end surface of one end of the air inlet channel 130 close to the heating element 120 along the longitudinal direction. In other words, top ends of the first airflow guide wall 1521 and the second airflow guide wall 1522 are higher than a top end of the air inlet channel 130, so that the first airflow guide wall 1521 and the second airflow guide wall 1522 can have a better airflow guide effect. When exiting from the opening portion of the air inlet channel 130, the airflow is encased by the airflow guide wall and guided away, thereby avoiding a case that the airflow is excessively dispersed after exiting from the air inlet channel 130.

With reference to FIG. 3, the mounting substrate 110 includes a first end a and a second end b opposite to each other along the longitudinal direction. As shown in FIG. 3, an opening 1113 is provided at the first end a of the mounting substrate 110. The opening 1113 communicates with the liquid storage cavity 111, and liquid is injected into the liquid storage cavity 111 through the opening 1113.

As shown in FIG. 3, the electronic atomization device 100 further includes a suction nozzle 160. The suction nozzle 160 is clamped to the first end a of the mounting substrate 110. In a finished product of the electronic atomization device 100 of this embodiment of this application, the suction nozzle 160 is separated from a main body of the electronic atomization device 100, and the opening 1113 at the top of the liquid storage cavity 111 is exposed. During use, liquid is injected into the liquid storage cavity 111, and the suction nozzle 160 is buckled and clamped to the mounting substrate 110, to complete assembly, and form the integrated electronic atomization device 100.

With reference to FIG. 3 and FIG. 5, the electronic atomization device 100 further includes a first sealing member 161. The first sealing member 161 is disposed at the opening 1113, and is configured to seal the opening 1113. During assembly, after the liquid is injected into the liquid storage cavity 111, the first sealing member 161 covers the opening 1113 of the liquid storage cavity 111 to seal the liquid storage cavity 111, and then the suction nozzle 160 covers the first end of the mounting substrate 110 and is tightly clamped. The suction nozzle 160 can tightly compress the first sealing member 161, to avoid liquid leakage from the liquid storage cavity 111.

As shown in FIG. 1 and FIG. 3, the electronic atomization device 100 further includes a bottom cover 170 and a housing 180. The housing 180 is configured to accommodate the mounting substrate 110. The bottom cover 170 covers the second end b of the mounting substrate 110. The housing 180 is sleeved around the mounting substrate 110. The suction nozzle 160, the housing 180, and the bottom cover 170 jointly define an external surface of the electronic atomization device 100.

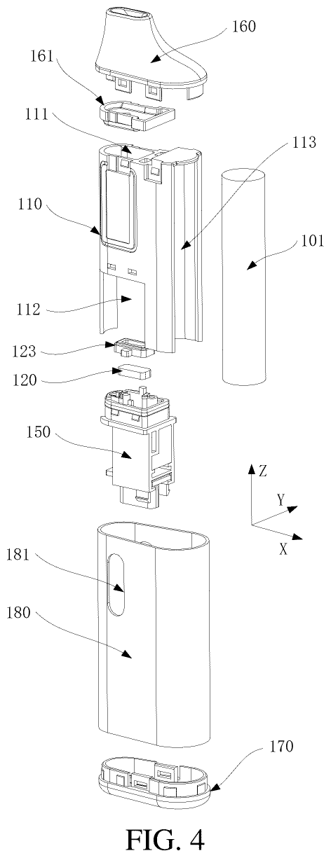

As shown in FIG. 4, a bottom end of the battery cavity 113 on the mounting substrate 110 is open, and after the battery 101 is loaded into the battery cavity 113, the bottom of the battery 101 is fixed by using the bottom cover 170.

Still with reference to FIG. 4, one side of the battery cavity 113 may also be open. In this way, a side wall of the battery cavity 113 may be in a hoop shape. The hoop shape enables the battery cavity 113 to be deformed to adapt to a size of the battery 101. Meanwhile, the battery 101 can be tightly clamped. In addition, materials can be saved.

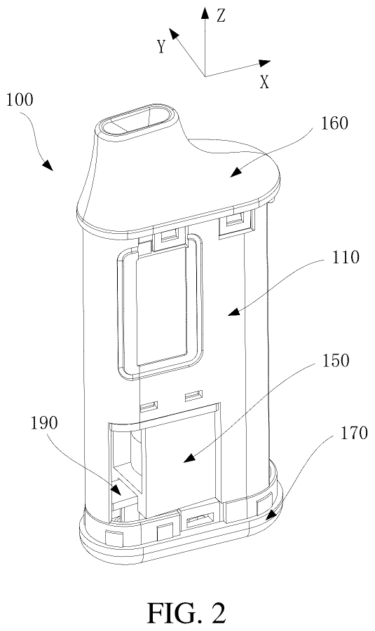

In this embodiment of this application, with reference to FIG. 2 and FIG. 3, the mounting base 150 is connected to the mounting substrate 110 through clamping. A clamping hole is provided on a wall surface of the mounting cavity 112 of the mounting substrate 110, and a clamping convex is provided on the mounting base 150. The clamping convex can be clamped into the clamping hole to fix the mounting base 150 to the mounting substrate 110. As shown in FIG. 2 and FIG. 3, the bottom cover 170 is clamped to the mounting base 150. A clamping buckle is disposed on one end of the mounting base 150, and a clamping hole is provided on the bottom cover 170.

As shown in FIG. 3, in this embodiment of this application, at least a part of the mounting substrate 110 is set to a transparent structure A, to observe a condition of the liquid substrate in the liquid storage cavity 111 through the transparent structure A. Meanwhile, a window 181 corresponding to the transparent structure A may be disposed on the housing 180. The window 181 may expose the transparent structure, so that the liquid substrate in the liquid storage cavity 111 is observed through the window 181 and the transparent structure. As shown in FIG. 3, the transparent structure A may be disposed on at least one of two sides of the mounting substrate 110 along the thickness direction (the direction Y) of the mounting substrate 110. In other words, the transparent structure A may be disposed on a front side and/or a rear side of the mounting substrate 110. In this embodiment of this application, because the liquid storage cavity 111 does not include the center air tube, when the liquid storage cavity is observed through the transparent structure A on the front side and/or the rear side of the mounting substrate 110, there is no interference of the center air tube. Therefore, the condition of the liquid substrate can be clearly observed.

As shown in FIG. 5, in this embodiment of this application, the electronic atomization device 100 further includes a circuit board 190 and an airflow sensor 191. The circuit board 190 and the airflow sensor 191 are both mounted on the mounting base 150. Therefore, the mounting cavity 112 is used to accommodate the circuit board 190 and the airflow sensor 191. The airflow sensor 191 is connected to the circuit board 190, and the heating element 120 is also connected to the battery 101 by using the circuit board 190. The airflow sensor 191 is configured to detect an inhaled airflow. When the airflow sensor 191 detects the airflow, a circuit on the circuit board 190 is turned on, to power up the heating element 120.

Still with reference to FIG. 5, an airflow sensor mounting cavity 155 and an airflow channel 156 are disposed on the mounting base 150. The airflow sensor mounting cavity 155 is configured to mount the airflow sensor 191. The airflow channel 156 communicates the airflow sensor mounting cavity 155 with the atomization cavity 151. With reference to FIG. 5, one side of the airflow sensor 191 communicates with the external air. As shown in FIG. 5, the other side of the airflow sensor 191 is sealed in the airflow sensor mounting cavity 155, and the airflow sensor mounting cavity 155 communicates with the atomization cavity 151. The airflow sensor mounting cavity 155 may be sealed by using a third sealing member 1551. When the user inhales from the suction nozzle 160, a vacuum is formed in the atomization cavity 151, to be specific, the vacuum is formed in the airflow sensor mounting cavity 155, so that an air pressure difference is formed at two sides of the airflow sensor 191. In this way, the airflow sensor 191 can implement a detection function.

More specifically, with reference to FIG. 3 and FIG. 5, an electrode post 153 is disposed at one end of the mounting base 150 close to the heating element 120, and the electrode post 153 is connected to the circuit board 190. Meanwhile, the electrode post 153 is in contact with the heating element 120 after the mounting base 150 is mounted in the mounting cavity 112, so that the heating element 120 can be powered up.

As shown in FIG. 3 and FIG. 5, the electronic atomization device 100 further includes a second sealing member 123. The second sealing member 123 is disposed between the mounting substrate 110 and the heating element 120, and is configured to seal a gap between the mounting substrate 110 and the heating element 120. The liquid substrate that flows out from the liquid outlet hole 1111 is prevented from leaking between the mounting substrate 110 and the heating element 120.

As shown in FIG. 3 and FIG. 5, fixing posts 154 are disposed on the mounting base 150, and the fixing posts 154 are configured to tightly press against the second sealing member 123. With reference to FIG. 5, the fixing posts 154 on the mounting base 150 tightly press against the second sealing member 123 after the mounting base 150 is mounted in the mounting substrate 110, and the electrode post 153 on the mounting base 150 presses against the heating element 120. The fixing posts 154 are disposed on two sides of the mounting base 150 along the direction Y, the electrode posts 153 are disposed at a middle position of the mounting base 150 along the direction Y, and there are two electrode posts 153.

As shown in FIG. 5, a charging port 171 is disposed on the bottom cover 170, and an external charging cable is connected to a charging interface on the circuit board 190 through the charging port 171, to charge the battery 101. The charging interface on the circuit board 190 is a Type-C interface.

It is clear that the foregoing embodiments of this application are merely examples for clearly describing this application, and are not intended to limit the implementations of this application. A person of ordinary skill in the art can make various obvious changes, readjustments, and replacements without departing from the protection scope of this application. Not all implementations need to and can be enumerated herein. Any modification, equivalent replacement, or improvement made within the spirit and principle of this application shall fall within the protection scope of the claims of this application.

What is claimed is:

1. An electronic atomization device, comprising:
a mounting substrate, wherein a liquid storage cavity is defined in the mounting substrate, and the liquid storage cavity is configured to store a liquid substrate;
a heating element, disposed on the mounting substrate, and configured to heat the liquid substrate to generate an aerosol; wherein the heating element comprises an atomization surface configured to release the aerosol;
a battery, disposed spaced away along a transverse direction on one side of the liquid storage cavity, and configured to supply power to the heating element;
an air inlet channel, serving as a channel to guide external air to the atomization surface; and
an air outlet channel, serving as a channel to deliver the atomized aerosol outward, wherein the air outlet channel is at least partially disposed between the liquid storage cavity and the battery; and the heating element comprises a first side and a second side opposite to each other, the atomization surface is defined between the first side and the second side, the air inlet channel is close to the first side, and the air outlet channel is close to the second side, to enable an airflow from the air inlet channel to flow from the first side to the second side and approach the atomization surface.

2. The electronic atomization device according to claim 1, further comprising:
a mounting base, wherein the mounting base is disposed spaced away from the atomization surface of the heating element, to form an atomization cavity between the mounting base and the heating element.

3. The electronic atomization device according to claim 2, wherein the air inlet channel is disposed on the mounting base, and the air outlet channel is disposed on the mounting substrate.

4. The electronic atomization device according to claim 2, wherein a vent channel is provided on the mounting substrate; and one end of the vent channel communicates with the liquid storage cavity, and the other end communicates with the atomization cavity;
a liquid outlet hole is provided on the mounting substrate, and the liquid outlet hole is configured to enable the liquid substrate in the liquid storage cavity to flow to the heating element; and
a port of the vent channel located in the liquid storage cavity is disposed spaced away from the liquid outlet hole.

5. The electronic atomization device according to claim 2, further comprising:
an airflow guide structure, wherein the airflow guide structure comprises a first airflow guide wall and a second airflow guide wall, the first airflow guide wall and the second airflow guide wall are oppositely disposed along a width direction of the heating element, and rear ends of the first airflow guide wall and the second airflow guide wall both extend to opposite sides, to converge the airflow.

6. The electronic atomization device according to claim 5, wherein the airflow guide structure is disposed on the mounting base.

7. The electronic atomization device according to claim 5, wherein the first airflow guide wall and the second airflow guide wall are both arc-shaped, a front end of the first airflow guide wall is connected to a front end of the second airflow guide wall, and a connection portion at least partially surrounds an opening portion of the air inlet channel.

8. The electronic atomization device according to claim 2, wherein an airflow sensor mounting cavity and an airflow channel are disposed on the mounting base, the airflow sensor mounting cavity is configured to mount an airflow sensor, and the airflow channel communicates the airflow sensor mounting cavity with the atomization cavity.

9. The electronic atomization device according to claim 1, wherein the mounting substrate comprises a first end and a second end opposite to each other along a longitudinal direction of the mounting substrate; and an opening is provided at the first end, and the opening communicates with the liquid storage cavity.

10. The electronic atomization device according to claim 1, wherein at least a part of the mounting substrate is set to a transparent structure, to observe the liquid substrate in the liquid storage cavity through the transparent structure.

11. The electronic atomization device according to claim 10, further comprising a housing configured to accommodate the mounting substrate, wherein at least one side of the housing along a thickness direction of the housing comprises a window that exposes the transparent structure.

12. The electronic atomization device according to claim 1, wherein the air outlet channel comprises a first air outlet channel and a second air outlet channel that extend in parallel in the mounting substrate.
